(19) United States
(12) Patent Application Publication
(10) Pub. No.: US 2003/0186444 A1
(43) Pub. Date: Oct. 2, 2003

(54) Method for characterizing molecular sieve catalysts

(76) Inventors: Jeffrey L. White, Kingwood, TX (US); Teng Xu, Houston, TX (US)

Correspondence Address: EXXONMOBIL CHEMICAL COMPANY, P O BOX 2149, BAYTOWN, TX, 77522-2149, US

(21) Appl. No.: 10/391,105

(22) Filed: Mar. 18, 2003

Related U.S. Application Data
(63) Continuation of application No. 09/593,620, filed on Jun. 13, 2000, now abandoned.

(51) Int. Cl. G01N 31/10

(52) U.S. Cl. 436/37; 436/173

(57) ABSTRACT

A method for characterizing molecular sieve catalysts by solid-state nuclear magnetic resonance spectroscopy. In particular, the number of acid and non-acid proton sites on molecular sieve catalysts are quantitively determined by solid-state ¹H NMR magic angle spinning spectroscopy in the presence of a spin-counting standard.

### FIELD OF THE INVENTION

The invention is directed to a method for characterizing molecular sieve catalysts by solid-state NMR. In particular, the number of active and inactive acid sites on molecular sieve catalysts are characterized by solid-state ¹H NMR magic angle spinning spectroscopy.

### BACKGROUND OF THE INVENTION

Olefins, particularly light olefins, have been traditionally produced from petroleum feedstocks by either catalytic or steam cracking. Oxygenates, however, are becoming an alternative feedstock for making light olefins, particularly ethylene and propylene. Promising oxygenate feedstocks are alcohols, such as methanol and ethanol, dimethyl ether, methyl ethyl ether, diethyl ether, dimethyl carbonate, and methyl formate. Many of these oxygenates can be produced from a variety of sources including synthesis gas derived from natural gas, petroleum liquids, and carbonaceous materials, including coal. Because of these relatively inexpensive sources, alcohol, alcohol derivatives, and other oxygenates have promise as an economical, non-petroleum source for light olefin production.

Molecular sieve catalysts, such as the microporous, crystalline zeolites and non-zeolites are known to promote the conversion of oxygenates to light olefins. Numerous patents describe this catalytic process: U.S. Pat. Nos. 4,499,327 and 4,677,242 to Kaiser; U.S. Pat. Nos. 5,095,163, 5,191,141, and 5,126,308 to Barger; as well as many others. The general characteristics of zeolite and non-zeolite molecular sieves which render them useful for oxygenate conversion and other chemical transformations is their uniform, microporous, crystalline structure and the acidity of the internal pore environment. The uniform and distinctly shaped pores dictate how the reactant interacts with the active site of the catalyst. The size of the pores limits which reactants can react with the active site and which products can exit the catalyst. It is this shape selectivity and size exclusivity which governs the product selectivity of the catalyst.

The crystalline zeolites comprise a corner-sharing AlO₂ and SiO₂ tetrahedra and are characterized by pore openings of uniform dimension. However, it is the crystalline non-zeolites that are generally utilized in the oxygenate conversion process. In general, non-zeolites do not contain AlO₂⁻ tetrahedra as essential molecular components of the molecular sieve framework. For example, SAPO comprises a three-dimensional microporous framework structure of [SiO₂], [AlO₂] and [PO₂] corner-sharing tetrahedra. The preferred SAPO catalyst for oxygenate conversion will have a relatively low Si/Al ratio. In general, the lower the Si/Al ratio, the lower the overall acidity of the catalyst, resulting in lower amounts of light paraffins being produced during the conversion process.

The catalytic activity in zeolites and non-zeolites occurs at or near acidic sites on a bridging oxygen framework located within the catalyst pores. Attached to these acidic sites are often relatively labile hydrogens, also referred to as protons. During the conversion process it is believed that the reactant, such as methanol, adsorbs onto the sieve framework at or near these acid sites. The adsorbed methanol then reacts with the acidic hydroxyl proton to form an intermediate hydrocarbon fragment. The hydrocarbon fragments then combine to form the desired light olefins and other hydrocarbon products. In either case the transfer of hydrogen from the acid sites of the catalyst to the reactant, and from the resulting adsorbed hydrocarbon intermediates back to the acid site is vital to the activity and selectivity of the catalyst, in particular a MTO catalyst. The relative degree and manner in which this transferring of hydrogens takes place is related to what is termed the acidity of the catalyst active sites. Therefore, it is important to characterize catalysts, particularly molecular sieve catalysts, by determining the number and type (strength) of the various acid sites on a particular catalyst. This information can then be catalogued and used to approximate the catalytic activity of a related family of catalysts.

Farneth and Gorte have recently reviewed the methods used to characterize both the strength and number of acid sites on a molecular sieve catalyst. W. E. Farneth and R. J. Gorte, Chemical Reviews, vol. 95, p. 615, 1995. The most common techniques involve adsorption or temperature programmed desorption (TPD) of NH₃, and infrared (IR) spectroscopy. However, neither of these methods are sufficiently reliable, as the NH₃ TPD methods suffer from multiple adsorbates per acid site. Quantification by infrared methods is limited by a lack of knowledge of molar extinction coefficients of the acidic hydroxyl groups and/or the respective adsorbate-proton complexes. Also, peak resolution is typically poor in IR spectra of solid catalysts because of the inherent breath of the OH absorption band.

Currently, the preferred methods for quantifying Bronsted sites involves combining TPD and thermogravimetric analysis (TGA) of reactive amines like isopropylamine. D. J. Parrillo, Applied Catalysis, vol. 67, p.107, 1990. The amine acting like a reactant is adsorbed at or near the acid site of a catalyst. The change in weight is then used to quantify the number of such sites. TGA is used to distinguish between the different types of acid sites since the strength of the adsorbant interactions will differ between sites. Others have used ³¹P NMR magic angle spinning (MAS) in conjunction with trimethylphosphine and trimethylphosphine oxide probe molecules to distinguish between Lewis and Bronsted acidity. J. H. Lunsford et al., J. American Chemical Society, vol.107, p.1540, 1985; K. J. Sutovich, J. Catalysis, vol.183, p. 155, 1999.

The present invention eliminates the need for a multistep site analysis approach such as combining TPD and TGA. Also, the invention eliminates the need to probe such sites by adding an adsorbant molecule, such as an amine or phosphine to the catalyst. Though the present invention can be used to investigate probe-acid site interations, the invention does not require that a probe molecule be used and a probe-acid site adsorption complex be formed. Also, the present invention does not possess the limitations inherent with TPD methods or IR spectroscopic methods briefly stated above.

### SUMMARY OF THE INVENTION

The present invention is of a solid-state ¹H NMR method that is used to characterize the active and inactive acid sites of molecular sieve catalysts. In particular, the invention not only assists in the identification of such sites, but more importantly, quantifies the density (or concentration) of each site, e.g., the number of acid sites per gram of catalyst by using a spin-counting standard, preferably polydimethylsiloxane (PDMS). Thus, the present invention can provide both qualitative and quantitative information for any heterogeneous acid catalyst independent of the specific crystallographic structure, pore size, pore/channel geometry, or chemical content of the catalyst. Although the use of ¹H solid-state NMR methods to investigate zeolite acidity is well known, there are no known reports that use a spin-counting standard to quantify Bronsted acidity in molecular sieve catalysts. Other NMR investigations of molecular sieve acid sites include: H. H. P. Yiu et al., Catal. Lett. vol. 59, p. 207, 1999; H. Pfiefer et al., Zeolites, vol. 5, p. 274, 1985; H. Pfeiffer J. Catalysis, vol. 127, p. 34, 1991; J. L. White et al, J. Am. Chem. Soc. vol. 114, p. 6182, 1992; and H. Liu et al J. Phys. Chem. B, vol. 103, p. 4786, 1999.

The invention provides a method for characterizing molecular sieve catalysts by solid-state NMR. In particular, the number of acid and non-acid sites on the molecular sieve catalyst is quantitively determined by solid-state ¹H NMR (MAS) spectroscopy using a spin-counting standard. The solid state NMR method of the present invention comprises: adding a known quantity of molecular sieve, preferably a zeolite or non-zeolite molecular sieve, and a known quantity of a spin-counting standard, preferably polydimethylsiloxane, to a NMR sample holder; acquiring a solid state NMR spectrum, preferably a ¹H NMR spectrum of the acid and non-acid protons of the molecular sieve in combination with the protons of the spin-counting standard; and determining the integrated areas for at least one signal associated with the molecular sieve and at least one signal associated with the spin-counting standard.

In the preferred embodiment a solid-state, NMR (MAS) spectrum is acquired by using a Bloch decay pulse sequence, preferably with a π/2 pulse. Preferably, the sample holder is spinned between 4 and 40 kHz, as the NMR data is acquired. Also, prior to determining the integrated areas of the spectrum signals the NMR data is converted by methods known in the art, preferably the NMR scan data is converted by Fourier calculations. If more than one scan is taken of the sample, then the time delay between scans is at least four times, preferably at least ten times, the spin-lattice relaxation time of the nucleus of interest in the molecular sieve and the spin-counting standard. Also, it is preferred that at least one spacer be added to the sample holder such that the molecular sieve is confined to the middle third of the sample holder.

### BRIEF DESCRIPTION OF THE DRAWINGS

The present invention will be better understood by reference to the Detailed Description of the Invention when taken together with the attached drawings, wherein:

FIG. 1 is a schematic of a sample holder with two spacers which restrict the sample molecular sieve to the middle third of the holder;

FIG. 2a is a ¹H NMR (MAS) spectrum of SAPO-34 with PDMS standard;

FIG. 2b is a ¹H NMR (MAS) spectrum of SAPO-34 without PDMS standard;

FIG. 3 is a ¹H NMR (MAS) spectrum of relatively low Si/Al ratio ZSM-5 with PDMS standard; and

FIG. 4 is a ¹H NMR (MAS) spectrum of relatively high Si/Al ratio ZSM-5 with PDMS standard.

### DETAILED DESCRIPTION OF THE INVENTION

Solid state NMR is a spectroscopic technique that provides information on the types of acid sites present and their surrounding environment as well as the relative number of each type of acid site, given that precautions are taken to avoid signal saturation of one or more particular sites and the spin-counting standard. With respect to the acidity of solid surfaces one has to distinguish between two independent quantities: 1) Sₐ, the strength of acidity, which is defined as the ease of proton (hydrogen) transfer from a surface site to an adsorbant (Bronsted acidity) or of an electron pair transfer from an adsorbant, such ammonia, to a surface site Lewis acidity); and 2) Aₐ, the concentration of the respective acid sites.

The NMR signal is characterized by its relative position in the overall spectrum, i.e by its chemical shift (δ), and the area of the signal is used to quantify the relative concentration of a particular site in the molecular sieve. An absolute concentration can be determined by using an internal spin-counting standard. Thus, if one knows the concentration of the spin-counting standard in or around the sample, then the concentration of each particular acid site can be determined. To measure resonance chemical shifts in solid samples and to distinguish one acid site from another, line narrowing techniques, such as magic angle spinning (MAS), is utilized.

The application of NMR (MAS) to zeolites, non-zeolites, and related catalysts has become one of the most promising directions of research in catalyst development. See, J. M. Thomas et al. Angew. Chemie. vol. 22, p. 259 (1983). For example, since each particular acid site will interact differently with a given adsorbate, such as ammonia or pyridine, information as to the type and degree of acidity for the acid site can be qualitatively determined. Adsorption studies in zeolites and non-zeolites are of particular importance because hydrogen bonded adsorption complexes are proposed intermediates in the catalytic transformation of hydrocarbons. For example, it has been reported that methanol forms an extended adsorption complex with the Bronsted protons in H-ZSM-5. G. Mirth et al., J. Chemical Society Faraday Trans. vol. 86, p. 3039, 1990. ¹H NMR (MAS) has also been used to differentiate Bronsted acid sites from surface silanol groups and non-framework (external) hydroxyl groups. See, G. Engelhardt, High Resolution Solid-State NMR of Silicates and Zeolites; chapters 6 and 7, Wiley and Sons, New York 1987.

Molecular sieve comprises a three-dimensional microporous crystal framework structure of [SiO₂], [AlO₂] and [PO₂] corner sharing tetrahedral units. In general, silicoaluminophosphate molecular sieves comprise a molecular framework of corner-sharing [SiO₂], [AlO₂], and [PO₂] tetrahedral units. The silicoaluminophosphate molecular sieves are synthesized by hydrothermal crystallization methods generally known in the art. See, for example, U.S. Pat. Nos. 4,440,871; 4,861,743; 5,096,684; and 5,126,308, the methods of making of which are fully incorporated herein by reference. This type of framework is effective in converting various oxygenates into olefin products.

If a silicoaluminophosphate molecular sieve is used for the conversion of oxygenates a relatively low Si/Al ratio is preferred. In general, the lower the Si/Al ratio, the lower the C₁-C₄ saturates selectivity, particularly propane selectivity. A Si/Al ratio of less than 0.65 is desirable, with a Si/Al ratio of not greater than 0.40 being preferred. A Si/Al ratio of not greater than 0.20 is most preferred. Also, the preferred silicoaluminophosphate molecular sieves used in the oxygenate conversion process comprise 8, 10, or 12 membered ring structures. These ring structures can have an average pore size ranging from 3.5-15 angstroms. More preferred are the small pore SAPO molecular sieves having an average pore size of less than 5 angstroms, preferably an average pore size ranging from about 3.5 to 5 angstroms. These pore sizes are typical of molecular sieves having 8 membered rings.

The [PO₂] tetrahedral units within the framework structure of the molecular sieve of this invention can be provided by a variety of compositions. Examples of these phosphorus-containing compositions include phosphoric acid, organic phosphates such as triethyl phosphate, and aluminophosphates. The phosphorous-containing compositions are mixed with reactive silicon and aluminum-containing compositions under the appropriate conditions to form the molecular sieve.

The [AlO₂] tetrahedral units within the framework structure can be provided by a variety of compositions. Examples of these aluminum-containing compositions include aluminum alkoxides such as aluminum isopropoxide, aluminum phosphates, aluminum hydroxide, sodium aluminate, and pseudoboehmite. The aluminum-containing compositions are mixed with reactive silicon and phosphorus-containing compositions under the appropriate conditions to form the molecular sieve.

The [SiO₂] tetrahedral units within the framework structure can be provided by a variety of compositions. Examples of these silicon-containing compositions include silica sols and silicium alkoxides such as tetra ethyl orthosilicate. The silicon-containing compositions are mixed with reactive aluminum and phosphorus-containing compositions under the appropriate conditions to form the molecular sieve.

Substituted SAPOs can also be characterized by the present invention. These compounds are generally known as MeSAPOs or metal-containing silicoaluminophosphates. The metal can be alkali metal ions (Group IA), alkaline earth metal ions (Group IIA), rare earth ions (Group IIIB, including the lanthanoid elements: lanthanum, cerium, praseodymium, neodymium, samarium, europium, gadolinium, terbium, dysprosium, holmium, erbium, thulium, ytterbium and lutetium; and scandium or yttrium) and the additional transition cations of Groups IVB, VB, VIB, VIIB, VIIIB, IB, and IIB. Preferably, the Me represents metals such as Zn, Mg, Mn, Co, Ni, Ga, Fe, Ti, Zr, Ge, Sn, and Cr.

Suitable silicoaluminophosphate molecular sieves characterized by the present invention include SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, the metal containing forms thereof, and mixtures thereof. Preferred are SAPO-17, SAPO-18, SAPO-34, SAPO-35, SAPO-44, and SAPO-47, particularly SAPO-34, including the metal containing forms thereof, and mixtures thereof. As used herein, the term mixture is synonymous with combination and is considered a composition of matter having two or more components in varying proportions, regardless of their physical state.

An aluminophosphate (ALPO) molecular sieve can also be characterized by the invention. Aluminophosphate molecular sieves are crystalline microporous oxides which can have an AlPO₄ framework. They can have additional elements within the framework, typically have uniform pore dimensions ranging from about 3 angstroms to about 10 angstroms, and are capable of making size selective separations of molecular species. More than two dozen structure types have been reported, including zeolite topological analogues. A more detailed description of the background and synthesis of aluminophosphates is found in U.S. Pat. No. 4,310,440, which is incorporated herein by reference in its entirety. Preferred ALPO structures are ALPO-5, ALPO-11, ALPO-17, ALPO-18, ALPO-31, ALPO-34, ALPO-36, ALPO-37, and ALPO-46.

The ALPOs can also include a metal substituent in its framework. Preferably, the metal is selected from the group consisting of magnesium, manganese, zinc, cobalt, and mixtures thereof. These materials preferably exhibit adsorption, ion-exchange and/or catalytic properties similar to aluminosilicate, aluminophosphate and silica aluminophosphate molecular sieve compositions. Members of this class and their preparation are described in U.S. Pat. No. 4,567,029, incorporated herein by reference in its entirety. The metal containing ALPOs are sometimes referred to by the acronym as MeAPO. Also in those cases where the metal “Me” in the composition is magnesium, the acronym MAPO is applied to the composition. Similarly ZAPO, MnAPO and CoAPO are applied to the compositions which contain zinc, manganese and cobalt respectively. To identify the various structural species which make up each of the subgeneric classes MAPO, ZAPO, CoAPO and MnAPO, each species is assigned a number and is identified, for example, as ZAPO-5, MAPO-11, CoAPO-34 and so forth.

Molecular sieves catalysts that are mixed with inert matrix materials, such as clays, or binders, such as aluminochlorhydrol can also be characterized by the present invention. Materials which can be blended with the molecular sieve can be various inert or catalytically active materials, or various binder materials. These materials include compositions such as kaolin and other clays, various forms of rare earth metals, metal oxides, other non-zeolite catalyst components, zeolite catalyst components, alumina or alumina sol, titania, zirconia, magnesia, thoria, beryllia; quartz, silica or silica or silica sol, and mixtures thereof. These components are also effective in reducing, inter alia, overall catalyst cost, acting as a thermal sink to assist in heat shielding the catalyst during regeneration, densifying the catalyst and increasing catalyst strength. It is particularly desirable that the inert materials that are used in the catalyst to act as a thermal sink have a heat capacity of from about 0.05 to about 1 cal/g-° C., more preferably from about 0.1 to about 0.8 cal/g-° C., most preferably from about 0.1 to about 0.5 cal/g-° C.

Other molecular sieve materials can also be characterized by the invention either separately or when they are mixed with other catalytic components. Structural types of small pore molecular sieves that are suitable for use in this invention include AEI, AFT, APC, ATN, ATT, ATV, AWW, BIK, CAS, CHA, CHI, DAC, DDR, EDI, ERI, GOO, KFI, LEV, LOV, LTA, MON, PAU, PHI, RHO, ROG, THO, and substituted forms thereof. Structural types of medium pore molecular sieves that are suitable for use in this invention include MFI, MEL, MTW, EUO, MTT, HEU, FER, AFO, AEL, TON, and substituted forms thereof. These small and medium pore molecular sieves are described in greater detail in the Atlas of Zeolite Structural Types, W. M. Meier and D. H. Olsen, Butterworth Heineman, 3rd ed., 1997, the detailed description of which is explicitly incorporated herein by reference. Preferred molecular sieves which can be combined with a silicoaluminophosphate catalyst include ZSM-5, ZSM-34, erionite, and chabazite.

Also, catalytic materials that are subjected to a variety of treatments to achieve the desired physical and chemical characteristics, such as hydrothermal treatment, calcination, acid treatment, base treatment, milling, ball milling, grinding, spray drying, and combinations thereof, can also be characterized by the present invention. In other words, the acidity of the catalyst can be characterized by the present invention following any step of the preparative process. Thus, for example, one could investigate how various calcination procedures or how metal incorporation affects the catalyst's acidic properties.

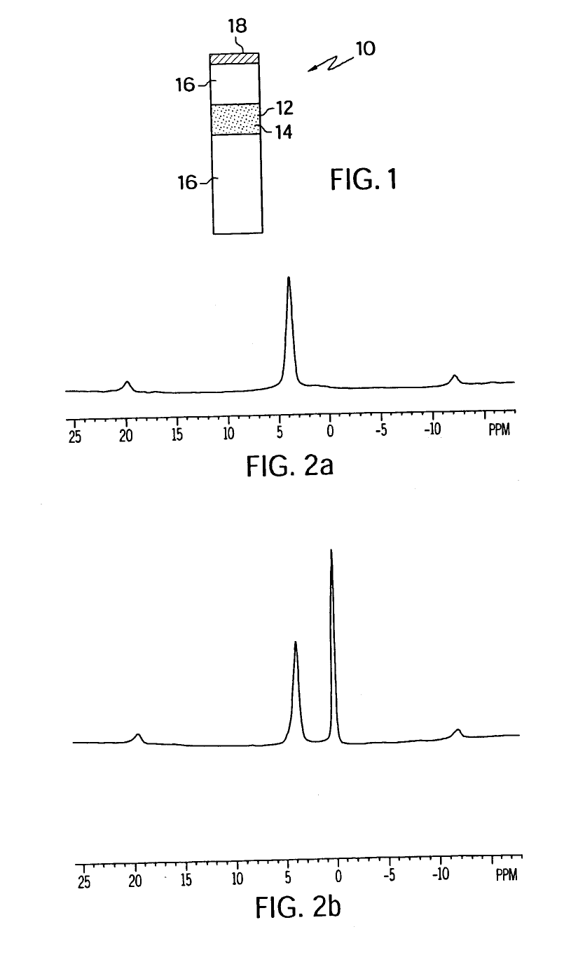

The preferred method of placing a catalyst sample 12 in the sample holder 10 for NMR data acquisition is shown in FIG. 1. The positioning of the sample in this way minimizes field inhomogeneties across the sample volume. Field inhomogeneties distort the signal response from that portion of the sample that is not centered about the receiver coil of the NMR probe. The result is an inaccurate count of acid sites in the total sample. The problem of field inhomogeneity is discussed in detail for a variety of commercial probes by Campbell et al., J. Magn. Reson., vol. 112A, p.225, 1995. The excitation profile is different for different probe vendors, but in general, is optimum at the center or middle third of the sample holder (rotor). Therefore it is preferred that the catalyst sample be confined to the middle third of the rotor volume in the present invention. For example, when a spectrum of hexamethylbenzene (HMB) and PDMS was obtained in which the HMB was placed outside the middle third of the rotor the absolute number of hydrogen in the HMB sample was 11% less than expected. However, when the HMB spectrum was obtained in which the HMB was confined to the middle third volume element of the rotor, as shown in FIG. 1, then the measured signal for the HMB was 98% of the expected value.

For the reasons stated above, the preferred embodiment of the invention comprises positioning the sample 12 within the middle third of the sample bolder (rotor) 10 volume. It is also preferred that the spin-counting standard 14 also be positioned in the middle third of the sample holder 10 volume. Spacers 16, known in the art, are positioned within the sample holder 10 as shown to confine the sample and spin-counting standard to the desired position. The sample holder also comprises a drive tip 18.

PDMS was chosen as the preferred spin-counting standard because it is an inert, solid material which is easily loaded into the sample rotor and which does not interact with the catalyst. More importantly, the ¹H linewidth is extremely narrow (Δυ_{1/2}≈120 Hz) because PDMS has a very low glass transition temperature. Further, the chemical shift for the methyl hydrogens is 0 ppm, which is removed from any peaks associated with most zeolite and non-zeolite catalysts. As a result, because there is no overlap between the spin-counting standard and the peaks associated the acid sites of the catalyst, integration and deconvolution of the sample peaks, if necessary, is relatively straightforward.

FIG. 2a depicts a ¹H NMR (MAS) spectrum of a SAPO-34 catalyst with PDMS. The spectrum of a SAPO-34 catalyst without PDMS is depicted in FIG. 2b. The SAPO-34 catalyst exhibits a peak at 3.8 ppm for the Bronsted acid sites, and a smaller, broader peak near 1.8 ppm for the non-acidic Al—OH and P—OH hydroxyl groups. A comparison of the spectra in FIG. 2 indicates there is no change in the spectral characteristics of the SAPO peaks upon addition of the PDMS.

The spectrum in FIG. 2b was deconvoluted into three peaks: the Bronsted acid site centered at 3.8 ppm; the PDMS peak centered at 0 ppm; and the non-acidic hydroxyls centered at 1.6 ppm. Based on the integration of the peaks, the SAPO-34 sample in FIG. 2a has a Bronsted acid site density of about 1.32 mmoles per gram of catalyst, and a non-acidic site density of about 0.1 mmols per gram of catalyst or about 7% of the total acid sites in the catalyst. Repeated measurements with the same SAPO-34 sample gave a standard deviation of about 4% for the Bronsted site density. The intensity of the first order spinning sidebands were also included in the calculation, while higher orders were neglected.

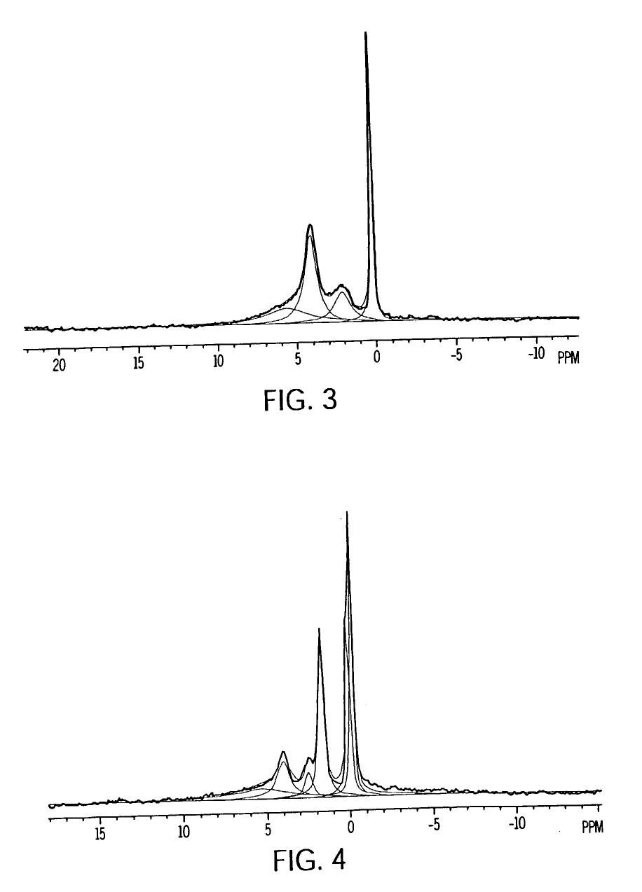

FIG. 3 and FIG. 4 depict the ¹H NMR (MAS) spectra of a low and high Si/Al ratio ZSM-5 catalyst with PDMS, respectively. As shown, the 4.2 ppm bridging hydroxyl peak is larger for the low Si/Al sample, FIG. 3. The assignments for the room temperature spectrum of ZSM-5 follow those of J. L. White et al., J. Am. Chem. Soc., vol.114, p. 6182, 1992, in that two distinct Bronsted acid sites exist. In addition to the 4.2 ppm peak, an additional peak near 6 ppm is also observed; it is the sum of these two resonances which are used to quantify the total Bronsted acidity in the ZSM-5 catalyst. Presumably, this second downfield acid site arises from the hydrogen bonding of a Bronsted hydroxyl group with a nearest neighbor oxygen. For the catalysts shown in FIG. 3 and FIG. 4, the Bronsted acid densities are estimated to be 0.44 and 0.86 mmoles per gram of catalyst, respectively.

This invention will be better understood with reference to the following example, which is intended to illustrate a specific embodiment within the overall scope of the invention as claimed.

### EXAMPLE 1

Solid-state ¹H NMR (MAS) spectra were acquired at about 500 MHz, and at spinning speeds of 8-12 kHz using a 4-mm spinning system. A one-pulse Bloch decay acquisition sequence (π/2 pulse widths were 3.8 μs) was used for all the measurements. Typically, 16 scans were collected using a recycle time of 70 seconds. This delay time was chosen to avoid signal saturation, and thus insure more accurate peak areas. The spin-counting standard, PDMS, has a T_{1H}=2.2 sec, while the longest T_{1H} for any measured molecular sieve catalyst was about 2 sec. All spectra were acquired at room temperature.

In a typical measurement, a known quantity of the PDMS spin-counting standard was added to the 4-mm MAS NMR rotor (of known weight) prior to packing the catalyst. Following a stepwise “activation” of the catalyst to remove moisture using a vacuum line, the MAS rotor was packed with a known quantity of catalyst inside an inert atmosphere glove box. The final temperature of the stepwise dehydration was 300-400° C. The catalyst weight inside the rotor was obtained by difference. Typically, 5-10 mg of catalyst and 50-150 μg of PDMS were used in each measurement.

Having now fully described the invention, it will be appreciated by those skilled in the art that the invention can be performed within a wide range of parameters within what is claimed, without departing from the spirit of the invention.

What is claimed is:

1. A solid state nuclear magnetic resonance method for characterizing acid sites of a molecular sieve comprising:
a) adding molecular sieve and a spin-counting standard to a nuclear magnetic resonance sample holder;
b) acquiring a solid state nuclear magnetic resonance spectrum of the molecular sieve in combination with the spin-counting standard; and
c) determining integrated areas for at least one signal associated with the molecular sieve and at least one signal associated with the spin-counting standard.

2. The method of claim 1 wherein the molecular sieve comprises zeolite or non-zeolite molecular sieve.

3. The method of claim 2 wherein the non-zeolite molecular sieve is selected from the group consisting of SAPO, MeSAPO, ALPO, MeALPO, and combinations thereof.

4. The method of claim 3 wherein the molecular sieve is SAPO-34.

5. The method of claim 2 wherein the zeolite molecular sieve comprises ZSM molecular sieve.

6. The method of claim 1 wherein the spin-counting standard comprises polydimethylsiloxane.

7. The method of claim 1 wherein acquiring the solid state nuclear magnetic resonance spectrum comprises acquiring a proton nuclear magnetic resonance spectrum.

8. The method of claim 1 wherein acquiring the solid state nuclear magnetic resonance spectrum comprises spinning the sample holder between 4 and 40 kHz.

9. The method of claim 1 wherein acquiring the solid state nuclear magnetic resonance spectrum comprises a Bloch decay sequence.

10. The method of claim 9 wherein the Bloch decay sequence comprises a π/2 pulse width of 4 μs.

11. The method of claim 1 wherein adding the molecular sieve and spin-counting standard to the sample holder comprises adding a known quantity of molecular sieve and a known quantity of spin-counting standard.

12. The method of claim 1 wherein acquiring the solid state nuclear magnetic resonance spectrum comprises acquiring more than one scan wherein a time delay between scans is at least four times the spin-lattice relaxation time of a nucleus of interest in the molecular sieve and the spin-counting standard.

13. The method of claim 1 wherein acquiring the solid state nuclear magnetic resonance spectrum comprises acquiring data using magic angle spinning methods.

14. The method of claim 1 wherein adding the molecular sieve and spin-counting standard to the sample holder further comprises adding at least one spacer.

15. The method of claim 14 wherein adding the molecular sieve, spin-counting standard, and at least one spacer comprises adding the molecular sieve such that the molecular sieve is confined to the middle third of the sample holder.
